(19) United States
(12) Patent Application Publication
(10) Pub. No.: US 2007/0001996 A1
(43) Pub. Date: Jan. 4, 2007

(54) Method of manufacturing liquid crystal display (LCD) without aging process and white balance adjustment apparatus

(75) Inventor: Jae-cheol Heo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/347,372

(22) Filed: Feb. 6, 2006

(30) Foreign Application Priority Data
Jun. 29, 2005 (KR) 2005-0056881

(51) Int. Cl. G09G 3/36

(52) U.S. Cl. 345/102

(57) ABSTRACT

A method of manufacturing a liquid crystal display (LCD) without an aging process. The method of manufacturing the LCD includes: assembling an LCD panel; heating a local area of the assembled LCD panel up to a predetermined target temperature; and adjusting a white balance by setting color coordinate and luminance when the predetermined target temperature is reached. Accordingly, an equipment investment cost and an equipment maintenance cost for the aging process can decrease, and a consumed power can decrease.

### CROSS-REFERENCE TO RELATED APPLICATIONS

This application claims benefit under 35 U.S.C. § 119 from Korean Patent Application No. 2005-56881, filed on Jun. 29, 2005, the entire content of which is incorporated herein by reference.

### BACKGROUND OF THE INVENTION

1. Field of the Invention

The present invention relates to a method of manufacturing a liquid crystal display (LCD) without carrying out an aging process, and in particular, to a method of manufacturing an LCD which removes an aging process and locally heats an LCD panel in the LCD manufacture process so that an equipment investment cost and an equipment maintenance cost for the aging process can decrease and a consumed power can decrease.

2. Description of the Related Art

In general, a process of manufacturing a thin film transistor (TFT) LCD panel is essentially carried out as a TFT process, a color filter process, a cell process, and a module process.

Two glasses processed by the TFT process and the color filter process are subject to the cell process so that one panel is made, which is then subject to the module process so that one TFT-LCD panel to be actually installed in a monitor or a television is made.

The TFT process is a process of forming a basic electrode, and forms an electrode of each cell. The color filter process is a process of forming a color filter for implementing Red, Green, and Blue colors (RGB). The cell process is a process of putting two glasses together and cutting them which have been subject to the TFT and color filter processes.

The module process is a final procedure of attaching a polarization plate, a PCB, a backlight unit, and so forth to the panel which has been subject to the cell process, which is then subject to an aging, final examination, and then packed and forwarded.

In general, the aging means that a material is made to be left at a proper temperature to cause complete physical and chemical changes. In a case of a broadcast station, the term “aging” means that a power is supplied to a camera, video tape recorder or the like and is examined for a long time to find out its durability.

When an LCD panel is manufactured, the aging means a process necessary for having uniform color coordinate and luminance in the panel set. Power is supplied to the panel set and the panel set is examined for a long time for setting the color coordinate and the luminance, thus carrying out white balance adjustment. The color coordinate and the luminance adjustment has the same meaning as the white balance adjustment herein.

FIG. 1 is a schematic view for explaining a method of manufacturing the LCD in accordance with the related art. FIG. 2 is a graph showing characteristics changing in the LCD panel and the backlight unit during the aging.

As shown in FIG. 1, the method of manufacturing the LCD of the related art includes an assembly process 10, an aging process 20, and a finish process 30.

The assembly process 10 is a process of assembling a polarization plate, a PCB, a backlight unit and so forth with the LCD panel. The assembled LCD panel is then subject to the aging process 20 where the assembled panel is provided with a power and left for about 40 minutes.

As shown in FIG. 2, it can seen that when about 40 minutes are elapsed after the power is supplied thereto, a change in luminance on the panel and a change in temperature in the backlight unit (BLU) become stabilized.

In addition, it can be seen that magnitudes (3.5 mA, 4.0 mA, 4.5 mA) of current flowing through the BLU are in proportion to the luminance on the panel, and are in proportion to the temperature in the BLU.

As such, the luminance of the panel depends on the temperature of the BLU. The color coordinate and the luminance, set when a power supply is turned off, with respect to the LCD are different from those when the power supply is turned on with respect to the LCD, that is, when the temperature increases. Accordingly, the color coordinate and the luminance need to be set after the aging of about 40 minutes.

After the aging where the luminance on the panel and the temperature in the BLU become stabilized, the white balance adjustment for setting the color coordinate and the luminance is carried out.

Accordingly, the method of manufacturing the LCD of the related art essentially carries out the aging process 20 after the assembly process 10, and then carries out the finish process 30 for adjustment and examination. In this case, the aging process 20 causes a large consumption of power and time.

In addition, equipment capable of driving many products for a long time is required in order to carry out the aging process, which excessively increases the equipment investment cost.

### SUMMARY OF THE INVENTION

It is therefore one aspect of the present invention to provide a method of manufacturing an LCD which is capable of decreasing the equipment investment cost and the equipment maintenance cost for the aging process. It is also an aspect of the present invention to provide a method of manufacturing an LCD which is capable of decreasing the consumed power by removing the aging process and locally heating the LCD panel in the LCD manufacture process.

According to one aspect of the present invention, there is provided a method of manufacturing the LCD, which includes: assembling an LCD panel; heating a local area of the assembled LCD panel up to a predetermined target temperature; and adjusting a white balance by setting color coordinate and luminance when the predetermined target temperature is reached.

The predetermined target temperature is preferably, but not necessarily, in a range of 40° C.±1° C.

According to another aspect of the present invention, there is provided a white balance adjustment apparatus, which includes: a heating unit of heating a local area on a liquid crystal display (LCD) panel; a temperature sensor unit of detecting a temperature of the heated local area; a memory unit of storing color coordinate and luminance information; an adjustment unit of adjusting the white balance by setting the color coordinate and luminance of the LCD panel in response to the color coordinate and luminance information stored in the memory unit; and a control unit of making the adjustment unit carry out the white balance adjustment when the detected temperature reaches a predetermined target temperature.

The predetermined target temperature is preferably, but not necessarily, in a range of 40° C.±1° C.

According to another aspect of the present invention, there is provided a method of adjusting a white balance, which includes: heating a local area on a liquid crystal display (LCD) panel; determining whether a temperature of the heated local area is a predetermined target temperature; and adjusting color coordinate and luminance by setting predetermined color coordinate and luminance when the temperature of the heated local area reaches the predetermined target temperature.

The predetermined target temperature is preferably, but not necessarily, in a range of 40° C.±1° C.

### BRIEF DESCRIPTION OF THE DRAWINGS

The above aspects and features of the present invention will be more apparent by describing exemplary embodiments of the present invention with reference to the accompanying drawings, in which:

FIG. 1 is a schematic view for explaining a method of manufacturing an LCD of the related art;

FIG. 2 is a graph illustrating characteristic changes of an LCD panel and a backlight unit during aging;

FIG. 3 is a schematic view for explaining a method of manufacturing an LCD in accordance with the present invention;

FIG. 4 is a block view illustrating a structure of a white balance adjustment apparatus in a process of manufacturing an LCD in accordance with an exemplary embodiment of the present invention;

FIG. 5 is a flow chart for explaining a method of adjusting a white balance in a process of manufacturing an LCD in accordance with an exemplary embodiment of the present invention;

FIG. 6A is a graph illustrating a change in luminance in response to a change in temperature;

FIGS. 6B and 6C are graphs illustrating changes in color on a color coordinate in response to a change in temperature; and

FIG. 7 is a graph illustrating a change in transmittance of an LCD in response to a change in applied voltage.

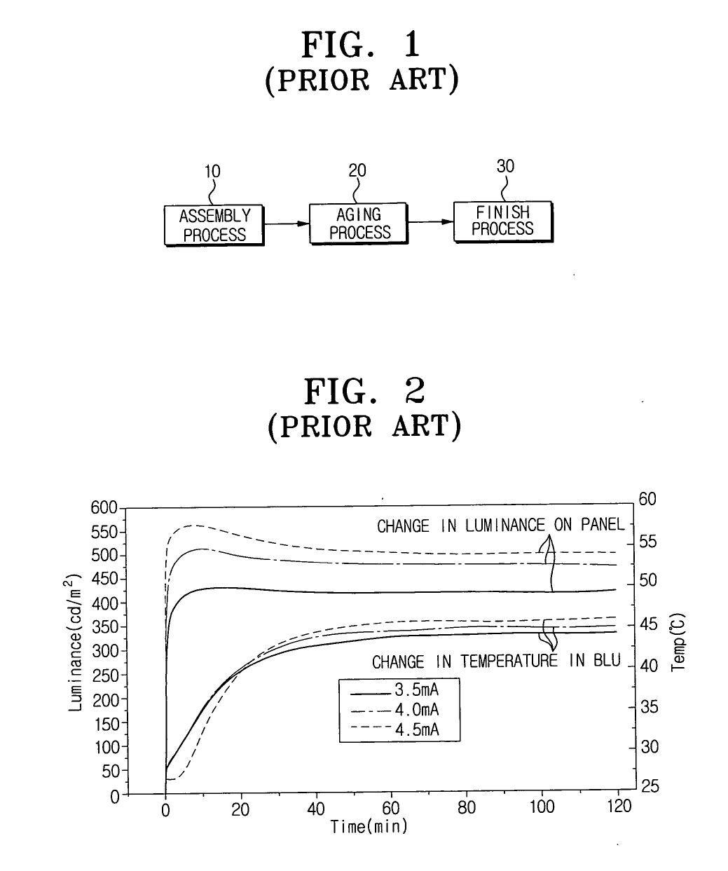

### DETAILED DESCRIPTION OF THE EXEMPLARY EMBODIMENTS

Hereinafter, the present invention will be described in detail with reference to accompanying drawings.

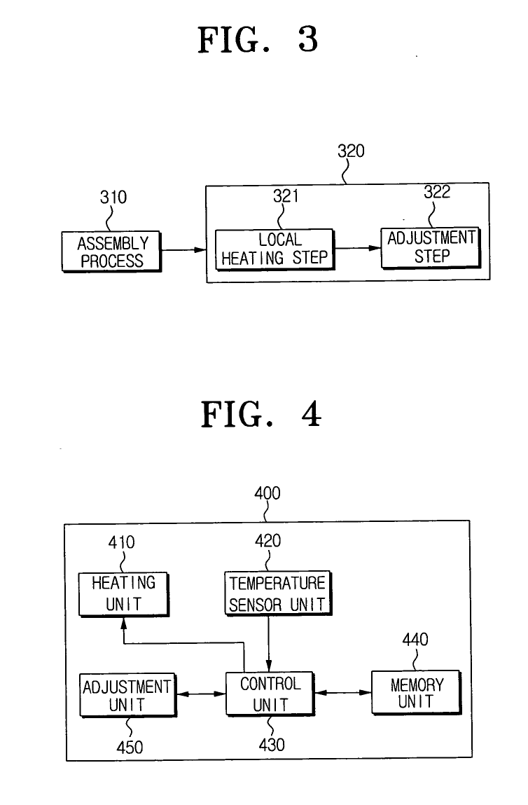

FIG. 3 is a schematic view for explaining a method of manufacturing an LCD in accordance with the present invention.

As shown in FIG. 3, the present invention includes an assembly process 310 and a finish process 320. In addition, the finish process 320 includes a local heating step 321 and an adjustment step 322.

The assembly process 310 assembles a polarization plate, a PCB, and a BLU with the LCD panel. A local area of the assembled LCD panel is heated up to a predetermined target temperature so that the local area can be subject to aging.

When the target temperature is reached where a luminance on the panel and a temperature in the BLU are stabilized, the finish process 320 of adjusting a white balance is carried out for setting the color coordinate and the luminance.

FIG. 4 is a block view illustrating a structure of a white balance adjustment apparatus in a process of manufacturing the LCD in accordance with an embodiment of the present invention.

As shown in FIG. 4, the white balance adjustment apparatus 400 according to the present invention includes a heating unit 410, a temperature sensor unit 420, a control unit 430, a memory unit 440, and an adjustment unit 450.

A local area on the LCD panel is heated by the heating unit 410. Any device capable of slowly heating the local area on the LCD panel may be employed as the heating unit 410. For example, a hair drier, a heater or the like may be employed to heat the local area only by means of a heating outlet of the heating unit 410.

The temperature sensor unit 420 detects a temperature of the heated area, and when temperature reaches a predetermined target temperature (e.g., 40° C.±1° C.), the control unit 430 examines predetermined color coordinate and luminance using the memory unit 440, and sends a control signal for adjustment with the predetermined color coordinate and luminance to the adjustment unit 450. The color coordinate and luminance information is stored in the memory unit 440.

The adjustment unit 450 adjusts the color coordinate and luminance in response to the control signal of the control unit 430 to adjust the color coordinate and luminance of the LCD panel. When the color coordinate and luminance reach target values, the control unit 430 sends a control signal to cause the adjustment of the adjustment unit 450 to be stopped.

Accordingly, when the local area only on the LCD panel is heated and a temperature of the area reaches the predetermined target temperature, a white balance of the entire LCD panel can be adjusted.

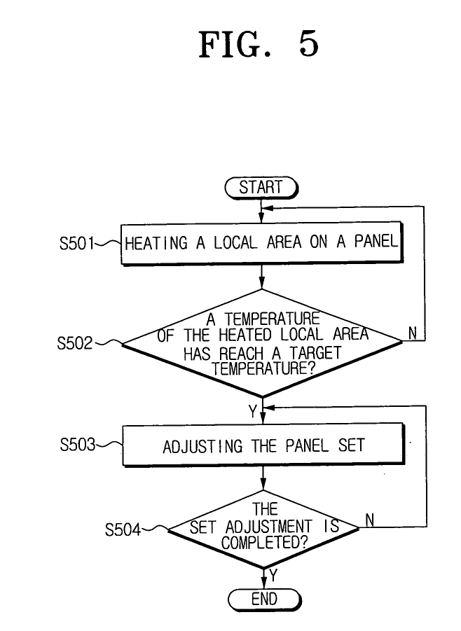

FIG. 5 is a flow chart for explaining a method of adjusting a white balance in a process of manufacturing an LCD in accordance with an exemplary embodiment of the present invention.

As shown in FIG. 5, a local area on the LCD panel is heated by the heating unit 410 (S501). The heating unit 410 slowly heats the local area on the LCD panel up to a predetermined target temperature. This corresponds to a case that the local area is subject to aging.

When the temperature sensor unit 420 disposed at the local area to be heated detects a temperature which has reached the predetermined target temperature (S502), the control unit 430 sends a control signal for adjusting predetermined color coordinate and luminance to the adjustment unit 450.

When the temperature does not reach the predetermined target temperature (S502), the heating unit 410 continues heating. In the meantime, the adjustment unit 450 adjusts the LCD panel set in response to the control signal of the control unit 430 (S503).

The adjustment unit 450 adjusts the color coordinate and luminance in response to the control signal of the control unit 403 to thereby adjust the color coordinate and luminance of the LCD panel. When the color coordinate and luminance reach target values, that is, when the set adjustment is completed (S504), the control unit 430 sends a control signal to the adjustment unit 450 to cause its adjustment to be stopped. Accordingly, the color coordinate and luminance of the LCD panel are set. When the set adjustment is not completed, the step S503 and the following steps are repeated.

Accordingly, when the local area only on the LCD panel is heated without the aging process and the local area reaches the predetermined target temperature, the color coordinate and luminance of the entire LCD panel can be set.

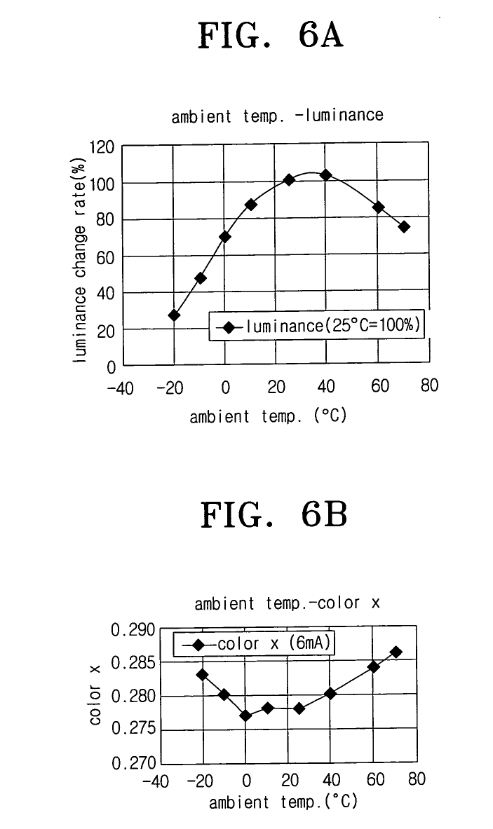

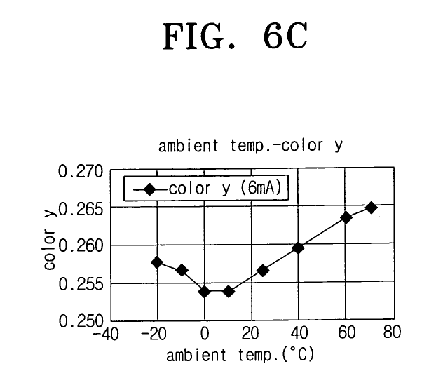

FIG. 6A is a graph illustrating a change in luminance in response to a change in temperature.

As shown in FIG. 6A, an ambient temperature of the horizontal axis indicates an external temperature of the BLU. When the ambient temperatures is 25° C., the luminance change rate is set to 100%. It can be seen from the experiment that the luminance change rate decreases whenever the ambient temperature centered on 25° C. increases or increases. This in turn leads to a fact that a mercury vapor pressure within the BLU is sensitive to the external temperature so that the luminance characteristic is changed in response to the ambient temperature.

FIGS. 6B and 6C are graphs illustrating color changes on a color coordinate in response to a change in temperature.

As is described with reference to FIG. 6A, an ambient temperature of the horizontal axis indicates an external temperature of the BLU. Referring to FIGS. 6B and 6C, it can be seen that the color coordinate is changed in response to the ambient temperature of the BLU when a current of 6 mA flows thorough the BLU. This means that the color coordinate depends on the temperature.

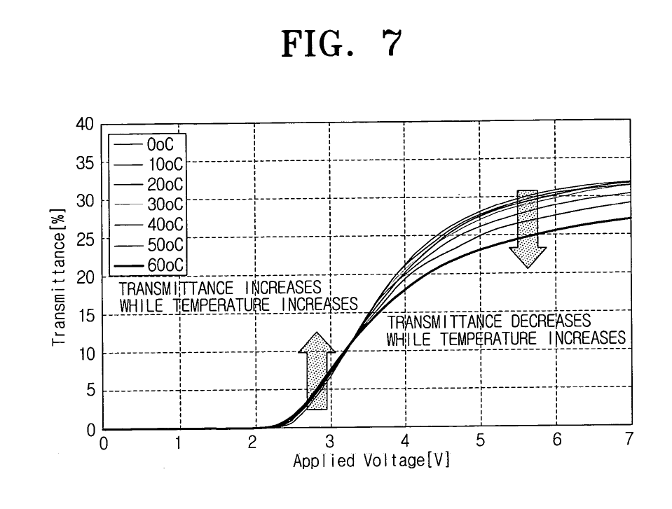

FIG. 7 is a graph illustrating a change in transmittance of an LCD in response to a change in applied voltage.

As shown in FIG. 7, it can be seen that a transmittance or an aperture ratio of the liquid crystal changes whenever the voltage applied to the BLU increases, and changes in response to the change in temperature before and after the specific voltage (i.e., about 3.5 V).

That is, referring to FIG. 7, when the applied voltage is lower than 3.5 V, the transmittance increases while temperature increases, however, when the applied voltage is higher than 3.5 V, the transmittance decreases while temperature increases. The change in transmittance means the change of color coordinate and luminance. Accordingly, it can be seen that the color coordinate and luminance change in response to the temperature.

FIGS. 6A to 7 are experimental results which show that the color coordinate and luminance of the LCD depend on the ambient temperature. Accordingly, at the time of manufacturing the LCD, the white balance adjustment for adjusting the color coordinate and the luminance must be carried out at a temperature as if the aging had been carried out. In the present invention, the aging process is removed, however, the white balance can be adjusted at the temperature as if the aging had been carried out.

According to the present invention as described above, the aging process is removed and the local area on the LCD panel is heated in a process of manufacturing the LCD, so that an equipment investment cost and an equipment maintenance cost can decrease and a consumed power can decrease. In addition, a productivity of manufacturing the LCD can be enhanced.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of manufacturing a liquid crystal display (LCD), comprising:
assembling an LCD panel;
heating a local area of the assembled LCD panel up to a predetermined target temperature; and
adjusting a white balance by setting color coordinate and luminance when the predetermined target temperature is reached.

2. The method according to claim 1, wherein the predetermined target temperature is in a range of 40° C.±1° C.

3. A white balance adjustment apparatus, comprising:
a heating unit which heats a local area on a liquid crystal display (LCD) panel;
a temperature sensor unit which detects a temperature of the heated local area;
a memory unit which stores color coordinate and luminance information;
an adjustment unit which adjusts the white balance by setting the color coordinate and luminance of the LCD panel in response to the color coordinate and luminance information stored in the memory unit; and
a control unit which controls the adjustment unit that performs the white balance adjustment when the detected temperature reaches a predetermined target temperature.

4. The white balance adjustment apparatus according to claim 3, wherein the predetermined target temperature is in a range of 40° C.±1° C.

5. A method of adjusting a white balance, comprising:
heating a local area on a liquid crystal display (LCD) panel;
determining whether a temperature of the heated local area is a predetermined target temperature; and
adjusting color coordinate and luminance by setting predetermined color coordinate and luminance when the temperature of the heated local area reaches the predetermined target temperature.

6. The method according to claim 5, wherein the predetermined target temperature is in a range of 40° C.±1° C.
